(19) United States
(12) Patent Application Publication
(10) Pub. No.: US 2022/0213971 A1
(43) Pub. Date: Jul. 7, 2022

(54) BREATHER PLUG FOR INSTALLATION ON LIQUID STORAGE TANKS

(71) Applicant: Heng-Yi HSU, Tainan City (TW)

(72) Inventor: Heng-Yi HSU, Tainan City (TW)

(21) Appl. No.: 17/140,837

(22) Filed: Jan. 4, 2021

(51) Int. Cl. F16K 24/02

(52) U.S. Cl. CPC F16K 24/02

(57) ABSTRACT

A breather plug for installation on liquid storage tanks has a main body with a hand-operated structure and an assembly structure which are connected. A flow channel penetrates the main body. A pinching part is formed on the radial periphery of the hand-operated structure. The fingers pinch the pinching part to rotate the main body. The assembly structure has a screwing section and a tapping section, so that said the body is installed on the tank body of the liquid storage tank through the assembly structure, allowing air to enter or leave the liquid storage tank through the flow channel. The pinching part is pinched by hand to rotate the main body, and the assembly structure is assembled on the liquid storage tank using the cutting action of the tapping section. As such, operation is easy and unlikely to fail.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to an article providing an air flow channel, and more particularly to a breather plug which can be installed on a liquid storage tank.

### 2. Description of Related Art Including Information Disclosed Under 37 CFR 1.97 and 37 CFR 1.98

The liquid storage tank is a container for storing liquid. Most liquid storage tanks are made of plastics for reducing the weight of the liquid storage tanks. When the liquid storage tank is tilted to discharge the liquid stored in the liquid storage tank, the liquid flows out of the opening of the liquid storage tank, and the outside air enters the liquid storage tank through the opening at the same time. The air flowing in opposite direction and the liquid are likely to push each other at the narrow opening, inducing unsmooth outward flow of the liquid.

As shown in FIG. 1, a conventional breather structure 10 which can be installed on a liquid storage tank comprises a breather pipe 12, a discharge stop ring 13 and a packing ring 14. Wherein the breather pipe 12 has a first end 122 and a second end 124. The first end 122 is opposite to the second end 124. The periphery of the breather pipe 12 is surrounded with a base 15, the base 15 is adjacent to the first end 122. The discharge stop ring 13 is fitted over the breather pipe 12. The packing ring 14 is screwed on the breather pipe 12 from the second end 124 to the first end 122, and the discharge stop ring 13 is located between the base 15 and the packing ring 14.

As shown in FIG. 2, a liquid storage tank 90 is molded from plastic material. The liquid storage tank 90 has a tank body 91, a space is formed inside the tank body 91 (not shown in the figure), the tank body 91 is provided with an opening 93, so that the liquid can enter or leave the space through the opening 93.

When the breather structure 10 is installed on the liquid storage tank 90, first of all, the tank body 91 is processed by using a drilling tool (not shown in the figure) to form a mounting hole 94. The mounting hole 94 penetrates the tank body 91. The inside diameter Φ1 of the mounting hole 94 must be a little larger than the outside diameter 12 of the breather pipe 12. A guide rope 16 is used as auxiliary means, the front section 162 of the guide rope 16 enters the space through the opening 93, and leaves the space through the mounting hole 94, so that the midsection 164 of the guide rope 16 is located in the space, the tail section 166 and the front section 162 of the guide rope 16 are located outside the tank body 91. In the case the packing ring 14 is removed, the tail section 166 penetrates the breather pipe 12 through the second end 124, and leaves the breather pipe 12 through the first end 122. The guide rope 16 guides the breather pipe 12 to move, the breather pipe 12 enters the space along the guide rope 16 and slides to the mounting hole 94. As the inside diameter Φ1 is larger than the outside diameter Φ2, the breather pipe 12 can be arranged in the mounting hole 94 out of the space, and the base 15 and the discharge stop ring 13 are located in the space. Afterwards, the packing ring 14 is screwed on the breather pipe 12, and the packing ring 14 is clamped and turned by using a spanner or other forms of hand tools, so that the packing ring 14 presses the outer surface 912 of the tank body 91. The base 15 presses the discharge stop ring 13, so that the discharge stop ring 13 abuts on the inner surface 914 of the tank body 91, the installation of the breather structure 10 is completed. Finally, the guide rope 16 is extracted from the breather pipe 12 and the liquid storage tank 90.

The breather structure 10 must be installed with the guide rope 16 and a hand tool. A person short of operating experience is likely to fail in the penetration of the guide rope 16, sliding the breather pipe 12 along the guide rope 16 to the mounting hole 94 and arranging the breather pipe 12 in the mounting hole 94 from inside to outside. The installation of the breather structure 10 is complicated and difficult.

### BRIEF SUMMARY OF THE INVENTION

The primary objective of the present invention is to provide a breather plug which can be installed on a liquid storage tank, it is a novel breather plug which is easy to be installed on a liquid storage tank.

Based on said objective, the present invention is a breather plug for installation on liquid storage tanks, including a main body and a blocking structure, wherein the main body is made of metal material. The main body comprises a hand-operated structure and an assembly structure which are axially connected. A flow channel axially penetrates the main body. The main body has a first side and a second side. Said first side is formed on the hand-operated structure. Said second side is formed on the assembly structure, and said first side and second side are opposite to each other in the axial direction of the main body. Said flow channel extends to the first side and the second side. An annular pinching part is formed on the radial periphery of the hand-operated structure, wherein the fingers pinch the pinching part to rotate the main body, so as to enhance the operation reliability of installing the main body on the liquid storage tank. Said pinching part forms a rough microstructure, so as to increase the surface friction of the pinching part. Said assembly structure has a screwing section and a tapping section, wherein said screwing section is located between the hand-operated structure and the tapping section. Said screwing section is cylindrical. Said tapping section is a tapered column. The radial dimension of said tapping section decreases from the screwing section to the second side. A first screw thread is formed on the periphery of the screwing section, wherein said first screw thread is a connecting screw thread. A second screw thread is formed on the periphery of the tapping section, wherein said second screw thread is a tapping screw thread. Said first screw thread and said second screw thread have the same helix angle and thread pitch, and the first screw thread and the second screw thread are connected integrally, so that the main body is installed on the tank body of the liquid storage tank through the assembly structure, and the air enters or leaves the liquid storage tank through the flow channel. Said blocking structure is disposed on the main body, so as to interrupt the connection between the flow channel and external environment through the first side.

In terms of main effect and advantage of the present invention, the pinching part can be nipped by hand to rotate the main body, the assembly structure is assembled on the tank body under the cutting action of the tapping section, the operation is easy and unlikely to fail.

Another objective of the present invention is to form a pinching part without a flat surface around the radial periphery of the hand-operated structure, so that the tool cannot clamp and pull the hand-operated structure to rotate excessively, the operation reliability of assembling the main body on the liquid storage tank is enhanced.

### BRIEF DESCRIPTION OF THE SEVERAL VIEWS OF THE DRAWINGS

FIG. 1 is the section view of the known breather structure installed on a liquid storage tank.

FIG. 2 is the three-dimensional diagram of the operating state of the known breather structure installed on a liquid storage tank.

FIG. 3 is the stereogram of the Embodiment 1 of the present invention.

FIG. 4 is the axial section view of the Embodiment 1 of the present invention.

FIG. 5 is the sectional view (I) of operating state of Embodiment 1 of the present invention installed on a liquid storage tank.

FIG. 6 is the sectional view (II) of operating state of Embodiment 1 of the present invention installed on a liquid storage tank.

FIG. 7 is the section view of Embodiment 1 of the present invention installed on a liquid storage tank.

FIG. 8 is the stereogram of the Embodiment 2 of the present invention.

FIG. 9 is the stereogram of the Embodiment 3 of the present invention.

FIG. 10 is the radial section view of the hand-operated structure in the Embodiment 3 of the present invention.

FIG. 11 is the drawing of partial enlargement of FIG. 10.

FIG. 12 is the sectional view of the Embodiment 4 of the present invention.

FIG. 13 is the section view of operating state of the Embodiment 5 the present invention.

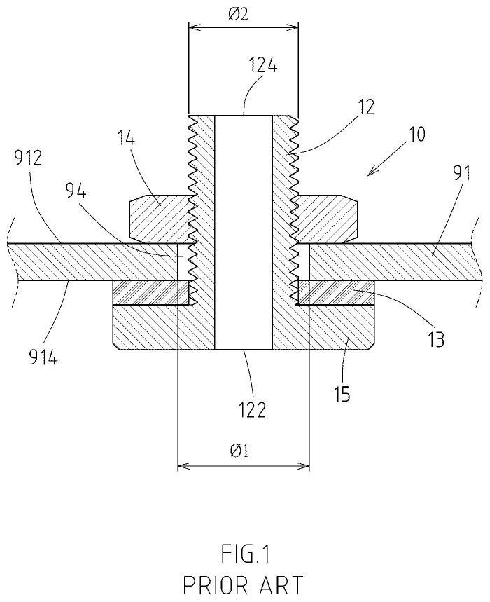

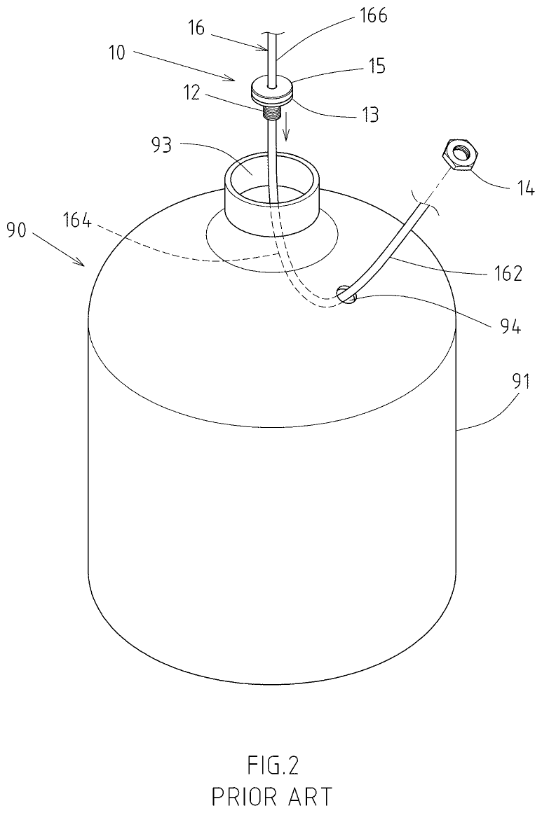

### DETAILED DESCRIPTION OF THE INVENTION

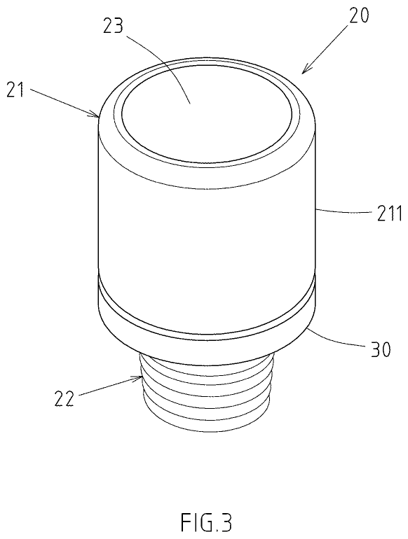

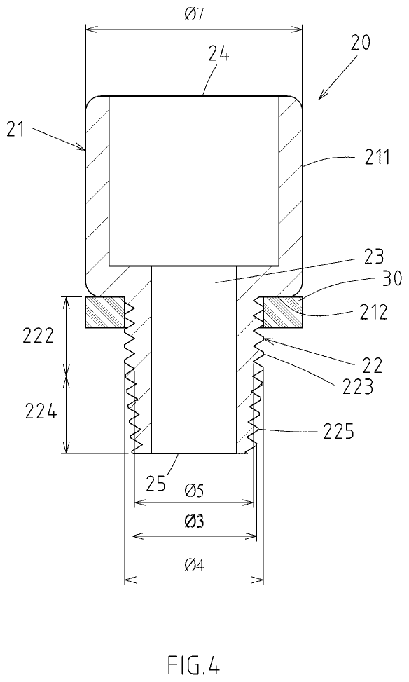

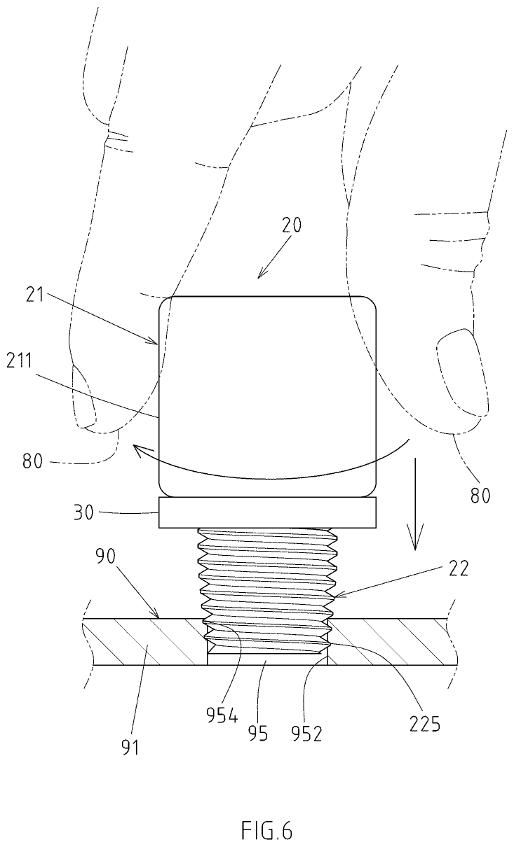

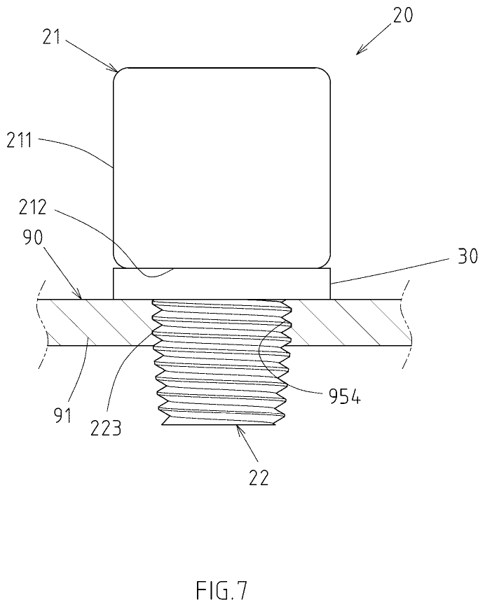

As shown in FIG. 3 to FIG. 7, the Embodiment 1 of the aforementioned breather plug which can be installed on a liquid storage tank comprises a main body 20, wherein the main body 20 is made of metal material. The main body 20 comprises a hand-operated structure 21 and an assembly structure 22 which are axially connected. The hand-operated structure 21 and the assembly structure 22 are formed integrally. A flow channel 23 axially penetrates the main body 20. The flow channel 23 penetrates the hand-operated structure 21 and the assembly structure 22. The main body 20 has a first side 24 and a second side 25. The first side 24 is formed on the hand-operated structure 21, the second side 25 is formed on the assembly structure 22, and the first side 24 and the second side 25 are opposite to each other in axial direction of the main body 20. The flow channel 23 extends to the first side 24 and the second side 25.

The radial periphery of the hand-operated structure 21 forms an annular pinching part 211, so that the fingers 80 pinch the pinching part 211 to rotate the main body 20, to enhance the operation reliability of assembling the main body 20 on the liquid storage tank 90. An annular pressing face 212 is formed at one end of the hand-operated structure 21 facing the assembly structure 22. The annular inner edge of the pressing face 212 abuts on the assembly structure 22. Furthermore, the pinching part 211 without a flat surface is formed around the radial periphery of the hand-operated structure 21, so that the spanner or other forms of hand tools cannot effectively clamp and pull the hand-operated structure 21, the hand-operated structure 21 cannot be rotated with a hand tool, the operation reliability of assembling the main body 20 on the liquid storage tank 90 is enhanced.

The assembly structure 22 has a screwing section 222 and a tapping section 224. The screwing section 222 axially contacts the tapping section 224. The second side 25 is formed on the tapping section 224. The screwing section 222 is located between the hand-operated structure 21 and the tapping section 224. The screwing section 222 is cylindrical. The tapping section 224 is a tapered column, and the radial dimension of the tapping section 224 decreases from the screwing section 222 to the second side 25. A first screw thread 223 is formed on the periphery of the screwing section 222. The first screw thread 223 is a connecting screw thread. A second screw thread 225 is formed on the periphery of the tapping section 224. The second screw thread 225 is a tapping screw thread. The second screw thread 225 is a continuous screw thread. The first screw thread 223 and the second screw thread 225 have the same helix angle and thread pitch, and the first screw thread 223 and the second screw thread 225 are connected integrally, so that the main body 20 is installed on the tank body 91 of the liquid storage tank 90 through the assembly structure 22, and the air enters or leaves the liquid storage tank 90 through the flow channel 23.

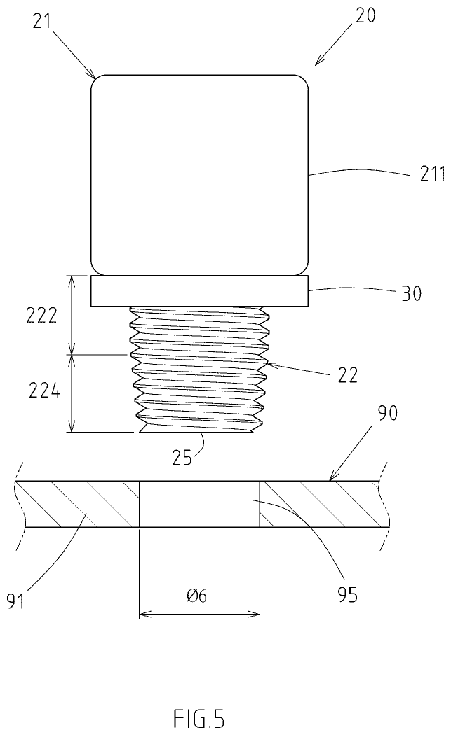

FIG. 5 to FIG. 7 describe the operation of installing Embodiment 1 on the liquid storage tank 90. A mounting hole 95 penetrates the tank body 91. Let the minimum outside diameter of the second screw thread 225 be Φ3, the outside diameter of the first screw thread 223 be Φ4, the minor diameter of root of the first screw thread 223 be Φ5, the inside diameter of the mounting hole 95 be Φ6, 06 is a little larger than Φ3, and Φ6 smaller than Φ4 is preferred.

The fingers 80 pinch the pinching part 211, so that the tapping section 224 enters the mounting hole 95 and rotates the main body 20, the second screw thread 225 cuts the hole wall 952 of the mounting hole 95. As the tapping section 224 enters the space inside the liquid storage tank 90 gradually (not shown in the figure), the hole wall 952 is processed by the tapping section 224 to form an internal thread 954 and guide the main body 20. Afterwards, the screwing section 222 enters the mounting hole 95, and the first screw thread 223 engages with the internal thread 954, the tapping section 224 enhances the handiness of installing the main body 20 on the tank body 91 through the screwing section 222.

When the Embodiment 1 is installed on the tank body 91, the tank body 91 is processed by using a tool to form the mounting hole 95, the user can pinch the pinching part 211 to rotate the main body 20 without any other tools, and then the assembly structure 22 can be assembled on the tank body 91 under the cutting action of the tapping section 224 on the hole wall 952, the operation is easy and unlikely to fail.

On the other hand, with the formation of the pinching part 211, the spanner or other forms of hand tools cannot effectively clamp and pull the hand-operated structure 21. When the main body 20 is installed on the tank body 91, the resistance of the tank body 91 to the assembly structure 22 makes the assembly structure 22 penetrate into the space continuously, preventing the tapping section 224 from overcutting the hole wall 952, the internal thread 954 will not be destroyed by the assembly structure 22, the screwing reliability of the first screw thread 223 and the internal thread 954 is enhanced.

A washer 30 is fitted over the assembly structure 22. The washer 30 is made of elastic material, and the washer 30 is adjacent to the pressing face 212. When the main body 20 is installed on the tank body 91, the pressing face 212 and the tank body 91 oppositely press the washer 30, so as to form a better discharge stop effect, preventing the liquid in the liquid storage tank 90 from leaking out between the assembly structure 22 and the hole wall 952. The assembly structure 22 is unlikely to get loose from the mounting hole 95 due to the elasticity of the washer 30.

The outside diameter Φ7 of the pinching part 211 is 10 mm-16 mm, the user is easy to pinch the pinching part 211 with the fingers 80, but difficult to grab the pinching part 211 with palm. The user will not apply excessive force to the pinching part 211, avoiding excessive rotation of the main body 20. In this case, the outside diameter Φ7 of the pinching part 211 is 14 mm.

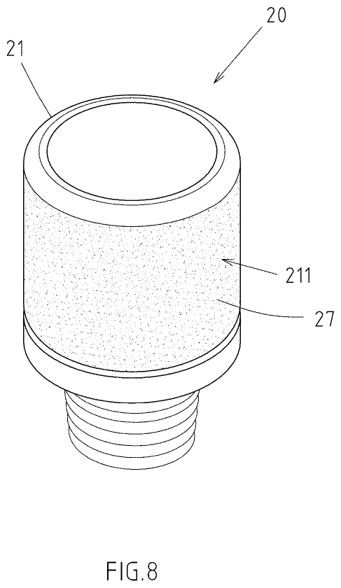

As shown in FIG. 8, the main difference of Embodiment 2 from Embodiment 1 is that the pinching part 211 forms a rough microstructure 27, so that the surface friction of the pinching part 211 is increased. The microstructure 27 is formed by sandblasting, peening or etching the pinching part 211.

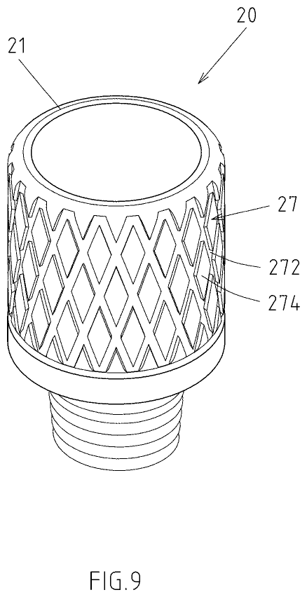

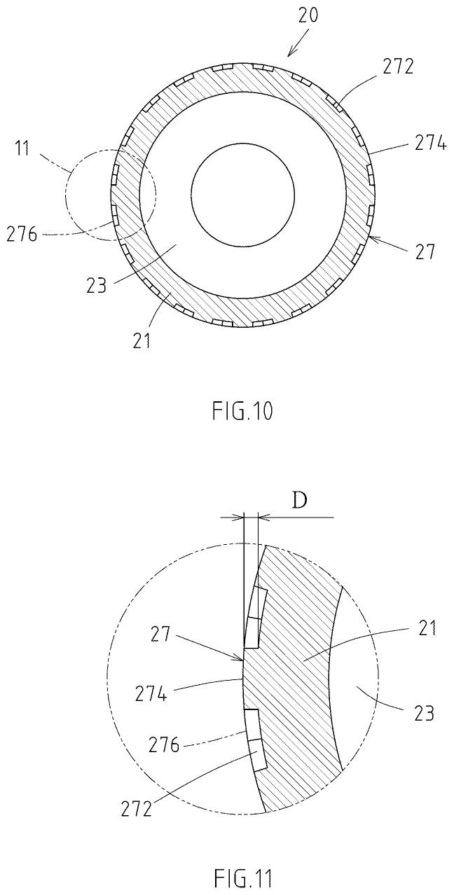

As shown in FIG. 9 to FIG. 11, the main difference of Embodiment 3 from Embodiment 2 is that the microstructure 27 is formed by rolling or etching the pinching part 211. The microstructure 27 comprises several dents 272 and several bulges 274. A virtual boundary 276 is defined, the boundary 276 is circular, and the center of the boundary 276 is exactly in the radial center of the hand-operated structure 21. The outer side of the bulges 274 far from the flow channel 23 is within the boundary 276. Along the diameter of the hand-operated structure 21, the distance D between the outer side of the bulge 274 and the inner side of the dent 272 smaller than 1 mm is a better implementation option.

Embodiment 2 and Embodiment 3 use the microstructure 27 to increase the relative friction between the fingers 80 and the pinching part 211, the user is easier to pinch the pinching part 211 with the fingers 80 to rotate the main body 20.

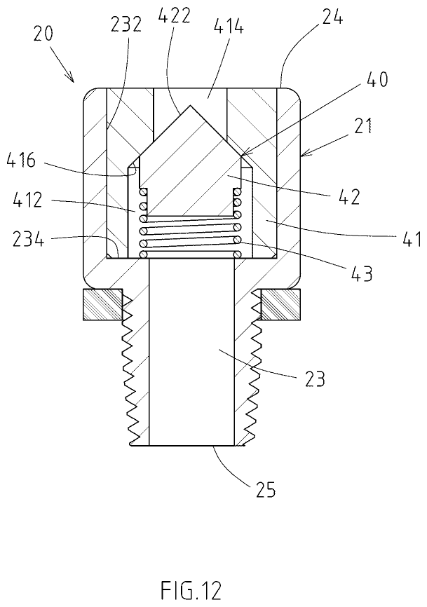

As shown in FIG. 12, the main difference of Embodiment 4 from Embodiment 1 is that the Embodiment 4 has a blocking structure 40, the blocking structure 40 is disposed on the main body 20, so as to interrupt the connection between the flow channel 23 and external environment through the first side 24.

The flow channel 23 expands to form a storage chamber 232, the storage chamber 232 extends to the first side 24, an annular abutting surface 234 is formed inside the storage chamber 232.

The blocking structure 40 comprises a limiting piece 41, a stop block 42 and a spring 43, wherein the limiting piece 41 is disposed in the storage chamber 232, a chamber 412 and a channel 414 are formed inside the limiting piece 41. The abutting surface 234 is located in the chamber 412. The chamber 412 communicates with the channel 414. The channel 414 extends to the first side 24. An annular limiting surface 416 is formed between the chamber 412 and the channel 414. The stop block 42 and the spring 43 are disposed in the chamber 412. The outside diameter of the stop block 42 is smaller than the inside diameter of the chamber 412. Both ends of the spring 43 prop the stop block 42 and the abutting surface 234 respectively, so that the stop block 42 props the limiting surface 416 to interrupt the connection between the chamber 412 and the channel 414.

The general situation, the stop block 42 interrupts the connection between the chamber 412 and the channel 414, the outside foreign materials cannot enter the liquid storage tank 90 through the flow channel 23. When the liquid storage tank 90 is tilted to discharge the liquid in the liquid storage tank 90, the pressure inside the space drops as the liquid flows out, forming a sucking action on the stop block 42, the stop block 42 moves towards the space, the stop block 42 leaves the limiting surface 416, the chamber 412 communicates with the channel 414, the air can enter the liquid storage tank 90 through the channel 414, the chamber 412 and the flow channel 23, and the liquid flows out smoothly.

Furthermore, the inside diameter of the limiting surface 416 decreases from the chamber 412 to the channel 414, so that the limiting surface 416 is conical. The stop block 42 has a conical end 422, so that the end 422 props the limiting surface 416, enhancing the reliability of the stop block 42 obstructing air. The end 422 and the limiting surface 416 have the same coning angle, so the end 422 adhering to the limiting surface 416 is a better implementation option.

The blocking structure 40 can be provided with a conical limiting surface 416 or a conical end 422, so as to form a different embodiment based on Embodiment 4.

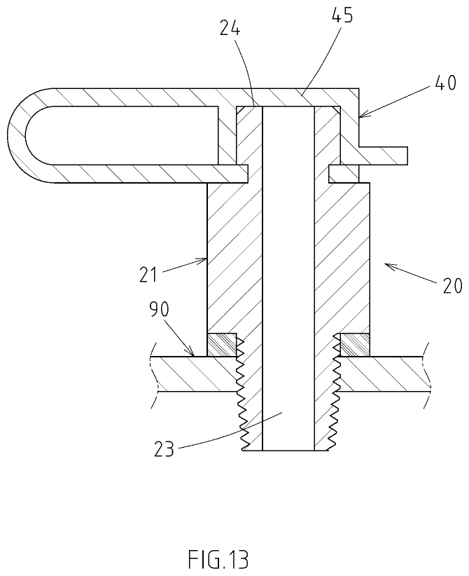

As shown in FIG. 13, the main difference of Embodiment 5 from Embodiment 1 is that the Embodiment 5 has a blocking structure 40, the blocking structure 40 has a close over 45, the close over 45 is removably installed on the first side 24, so as to interrupt the connection between the flow channel 23 and external environment through the first side 24.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A breather plug for installation on a tank body of a liquid storage tank, the breather plug comprising:
a main body formed of a metal material, said main body having a hand-operated structure axially connected to an assembly structure, said main body having a flow channel extending axially thereinto, said main body having a first side and a second side, the first side being formed on the hand-operated structure, said second side being formed on the assembly structure, the first side and the second side being opposite each other, said flow channel extending to the first side and the second side, said assembly structure having a screwing section and a tapping section, the screwing section being located between the outlet structure and said tapping section, the screwing section being cylindrical, the tapping section being a tapered column, the tapping section having a radial dimension that decreases from the screwing section to the second side, the screwing section having a first screw thread formed on a periphery thereof, the tapping section having a second screw thread formed on a periphery thereof, the second screw thread being a tapping screw thread, the first screw thread and the second screw thread having an identical helix angle and an identical thread pitch, the first screw thread and the second screw thread being connected such that said main body is adapted to be installed on the liquid storage tank through the assembly structure and such that air enters or leaves the liquid storage tank through the flow channel, wherein only the screwing section engages the tank body and the tapping section does not engage the tank body when said main body is fully installed on the tank body; and
a pinching part formed around a radial periphery of the hand-operated structure, said pinching part being without a flat surface, said pinching part having a rough microstructure.

18. The breather plug of claim 17, wherein an annular pressing face is formed at an end of the hand-operated structure facing the assembly structure, the annular pressing face having an annular inner edge abutting the assembly structure, the assembly structure having a washer fitted thereover, the washer being formed of an elastic material, the washer being adjacent to the annular pressing face.

19. The breather plug of claim 17, wherein the rough microstructure of said pinching part comprises dents and bulges, the bulges having an outer side away from the flow channel and positioned in a circular boundary, a distance between an outer side of the bulges and an inner side of respective dents along a diameter of the hand-operated structure being less than one millimeter.

20. The breather plug of claim 17, wherein said pinching part has an outer diameter of between 10 millimeters and 16 millimeters.

21. The breather plug of claim 17, wherein the flow channel defines a storage chamber extending to the first side, the storage chamber having an annular abutting surface formed therein.
